(19) United States
(12) Patent Application Publication
(10) Pub. No.: US 2021/0191148 A1
(43) Pub. Date: Jun. 24, 2021

(54) EYEWEAR ATTACHMENT AND EYEWEAR ASSEMBLY

(71) Applicant: York TSAI, New Taipei City (TW)

(72) Inventor: York TSAI, New Taipei City (TW)

(21) Appl. No.: 16/894,936

(22) Filed: Jun. 8, 2020

(30) Foreign Application Priority Data
Dec. 23, 2019 (TW) 108147200

(51) Int. Cl. G02C 3/00; G02C 5/12

(52) U.S. Cl. CPC G02C 3/003; G02C 5/12

(57) ABSTRACT

An eyewear assembly includes a lens unit and an eyewear attachment mounted to the lens unit. The eyewear attachment includes a frame unit, an engaging unit and two connecting units and an elongate wearing unit. The engaging unit extends from the frame unit toward the lens unit and includes two positioning members extending respectively from upper and lower sides of the frame unit and detachably engaging the lens unit in such a manner that the frame unit is affixed on the lens unit. The connecting units are respectively and integrally connected to two lateral sides of the frame unit. The wearing unit interconnects the connecting units so as to allow an assembly of the frame unit, the connecting units and the wearing unit to be sleeved on the head of a user.

### CROSS-REFERENCE TO RELATED APPLICATION

This application claims priority to Taiwanese Patent Application No. 108147200, filed on Dec. 23, 2019.

### FIELD

The disclosure relates to eyewear assembly, more particularly to an eyewear assembly including a detachable eyewear attachment.

### BACKGROUND

For people who wear glasses, it is annoying that their glasses tend to slip down when their bodies are moving fiercely and sweating during exercise.

Referring to FIG. 1, a pair of conventional eyewear attachment is shown to include an inner frame 2 for confining a lens unit 11 of a pair of glasses 1, and a band 3 attached to two temples 12 of the glasses 1 by two clips 31. The glasses 1 are worn on the head of a user by the band 3 in a relatively loose manner. However, since the inner frame 2, the band 3 and the clips 31 are separate elements, it is troublesome to carry and assemble these elements together.

### SUMMARY

Therefore, an object of the present disclosure is to provide an eyewear attachment and an eyewear assembly capable of alleviating at least the drawback of the prior art.

According to one aspect of the disclosure, an eyewear attachment adapted to be mounted on a lens unit is provided. The lens unit includes a lens member having an inner surface and an outer surface opposite to the inner surface. The eyewear attachment includes a frame unit, at least one engaging unit, two connecting units and an elongated wearing unit. The engaging unit extends from the frame unit toward the lens unit and includes two positioning members that extend respectively from upper and lower sides of the frame unit and that are adapted to detachably engage the lens member in such a manner that the frame unit is affixed on the lens unit. The connecting units are respectively and integrally connected to two lateral sides of the frame unit. The wearing unit interconnects the connecting units so as to allow an assembly of the frame unit, the connecting units and the wearing unit to be sleeved on the head of a user.

According to another aspect of the disclosure, an eyewear assembly is provided. The eyewear assembly includes a lens unit and an eyewear attachment. The lens unit includes a lens member that has an inner surface and an outer surface opposite to the inner surface. The eyewear attachment is mounted on the lens unit, and includes a lens member having an inner surface and an outer surface opposite to the inner surface. The eyewear attachment includes a frame unit, at least one engaging unit, two connecting units and an elongated wearing unit. The engaging unit extends from the frame unit toward the lens unit and includes two positioning members that extend respectively from upper and lower sides of the frame unit and that detachably engage the lens member in such a manner that the frame unit is affixed on the lens unit. The connecting units are respectively and integrally connected to two lateral sides of the frame unit. The wearing unit interconnects the connecting units so as to allow an assembly of the frame unit, the connecting units and the wearing unit to be sleeved on the head of a user.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a pair of eyeglasses and a conventional band provided with two clips for retaining the eyeglasses thereon;

FIG. 2 is a partly exploded perspective view of a first embodiment according to an eyewear assembly of the present disclosure, illustrating the eyewear assembly including a lens unit and an eyewear attachment;

FIG. 3 is an assembled schematic top view of the first embodiment being sleeved on the head of a user, illustrating the eyewear attachment mounted on the lens unit;

FIG. 4 is a schematic side view of the first embodiment being sleeved on the head of a user;

FIG. 5 is a partly exploded perspective view of a second embodiment according to the eyewear assembly of the present disclosure;

FIG. 6 is an assembled perspective view of the second embodiment, illustrating the eyewear attachment mounted on the lens unit;

FIG. 7 is a partly exploded perspective view of a third embodiment according to the eyewear assembly of the present disclosure; and

FIG. 8 is an assembled perspective view of the third embodiment.

### DETAILED DESCRIPTION

Before the present disclosure is described in greater detail, it should be noted herein that like elements are denoted by the same reference numerals throughout the disclosure.

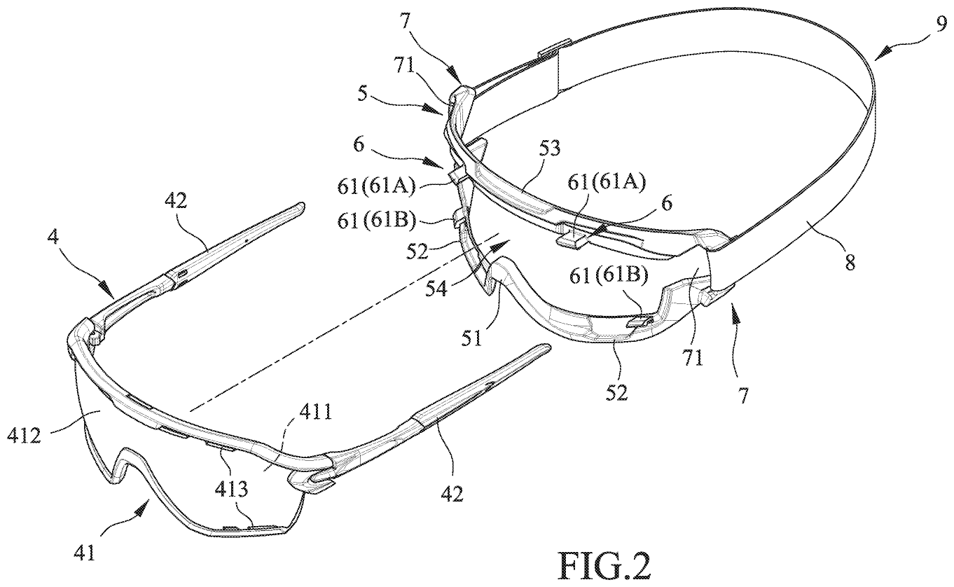

Referring to FIGS. 2 to 4, an eyewear assembly according to the first embodiment of the present disclosure is suitable to be worn by a user as sports goggles, and includes a lens unit 4 and an eyewear attachment 9. The eyewear attachment 9 is mounted on the lens unit 4, and includes a frame unit 5, at least one engaging unit 6, two connecting units 7 and an elongate wearing unit 8.

The lens unit. 4 includes a lens member 41 having an inner surface 411 and an outer surface 412 opposite to the inner surface 411 and two temple members 42 extending rearwardly from two lateral sides of the lens member 41. The lens member 41 is formed with a plurality of slots 413 extending through the inner and outer surfaces 411, 412.

The frame unit 5 includes a nose bridge pad 51 having an inverted-V shape, two lower frame members 52 respectively extending from two ends of the nose bridge pad 51 and respectively connected to the connecting units 7, and an upper frame member 53 disposed above the lower frame members 52 and interconnecting the connecting units 7. The nose bridge pad 51, the lower frame members 52 and the upper frame member 53 cooperate with one another to define a lens receiving space 54 confining the lens member 41 therein. The material for making the frame unit 5 can be one of plastic, silica gel, rubber and a combination thereof and the present disclosure is not limited to the material for making the frame unit 5.

The engaging unit 6 extends from the frame unit 5 toward the lens unit 4, and includes two positioning members 61 that extend respectively from upper and lower sides of the frame unit 5 and that detachably engage the slots 413 of the lens member 41. In this embodiment, the eyewear attachment 9 includes two engaging units 6 that are symmetrically disposed relative to the nose bridge pad 51. For the purpose of illustration, the upper ones of the positioning members 61 of the engaging units 6 are denoted by 61A and the lower ones of the positioning members 61 are denoted by 61B in the following description. The positioning members 61B extending respectively from the lower frame members 52 of the frame unit 5 are inclined forwardly and upwardly, and engage respectively the slots 413 formed in a lower portion of the lens member 41. The positioning members 61A extending from the upper frame member 53 of the frame unit 5 are inclined forwardly and downwardly, and engage respectively the slots 413 formed in an upper portion of the lens member 41, so that the frame unit 5 is affixed on the lens unit 4 by the engaging units 6. With the positioning members 61A, 61B extending inclinedly the lens member 41 is positioned relative to the frame unit 5. It should be noted that the configurations of the positioning members 61A, 61B are not limited to the example described herein and may be varied in other embodiments as long as the positioning members 61 are capable of engaging the lens member 41 for affixing the lens unit 4 to the frame unit 5.

The connecting units 7 are respectively and integrally connected to two lateral sides of the frame unit 5. Each of the connecting units 7 defines a temple passage opening 71 engaging a respective one of the temple members 42 so that lateral movement of the lens unit 4 relative to the connecting units 7 is prevented.

The wearing unit 8 interconnects the connecting units 7 so as to allow an assembly of the frame unit 5, the connecting units 7 and the wearing unit 8 to be sleeved on the head of a user. Note that the wearing unit 8 is one of an elastic band and a length adjustable strap with a buckle that can be adjusted to fit different sizes of the heads of different users. In this embodiment, the wearing unit 8 is connected to the frame unit 5 by the connecting units 7, so that assembly of the wearing unit 8 to the frame unit 5 is not required.

Before the lens unit 4 is attached to the eyewear attachment 9, an assembly of the frame unit 5 and the wearing unit 8 is sleeved on the head of the user. Then, the temples 42 of the lens unit 4 are brought to extend through the temple passage openings 71 of the connecting units 7, respectively. Subsequently, the positioning members 61A, 61B are snapped into the slots 314 so as to affix the lens unit 4 on the frame unit 5, and thus the eyewear assembly can be served as goggles, sports goggles, etc. In this way, the lens unit 1 is confined in the lens receiving space 54 by the engaging units 6, the connecting units 7 provide lateral engaging force to the temple members 42, and the wearing unit 8 provides positioning force in the front-rear direction.

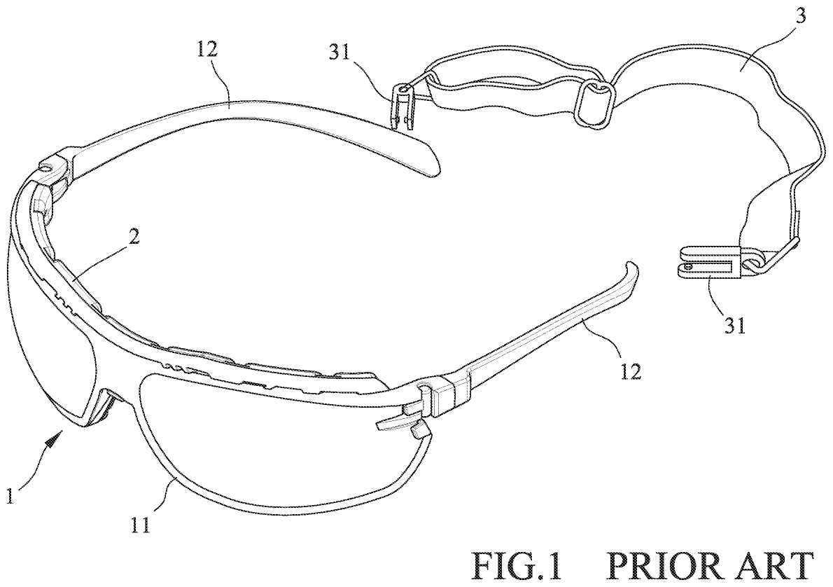

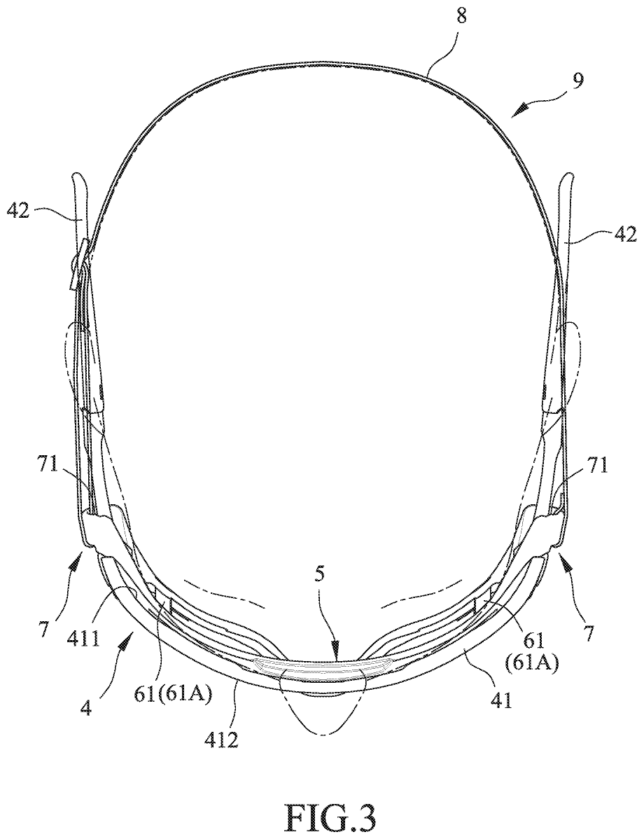

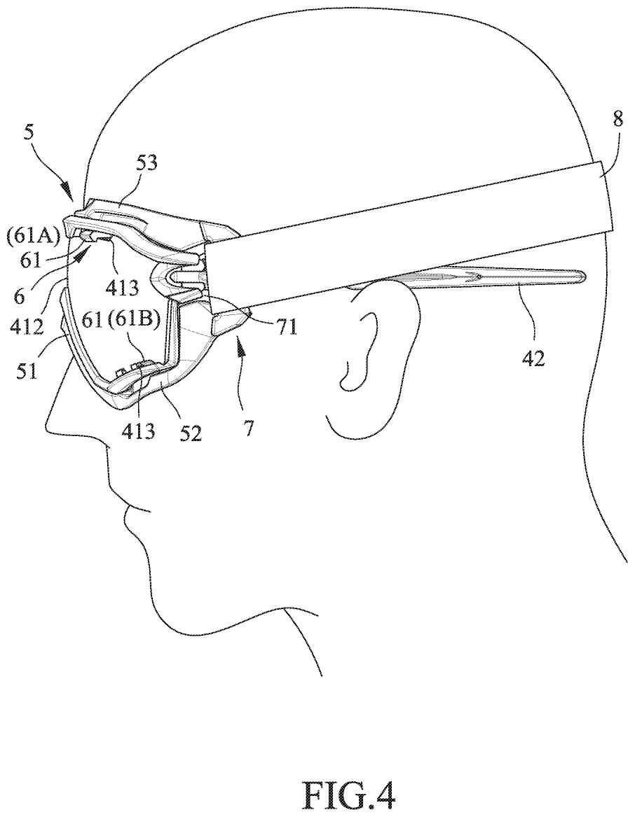

To take off the eyewear assembly, the wearing unit 8 is pulled away from the head of the user and then the eyewear assembly can be worn around the neck of the user. When it is not required to enhance the connection strength between the lens unit 4 and the head of the user, the wearing unit 8 is first pulled away from the head of the user and then the lens unit 4 is detached from the frame unit 5 so that the lens unit 4 can be worn directly on the head of the user as a pair of glasses. Additionally, the eyewear attachment 9 can be worn around the neck of the user or be folded and stored. As compared to the conventional band 3 including two clips 31 shown in FIG. 1, no additional assembly and disassembly for the eyewear attachment 9 of the present disclosure is required. It should be noted that the relationship between the head of the user and the eyewear assembly shown in FIGS. 3 and 4 is merely for illustration and may be varied since the sizes of heads of different users are not identical.

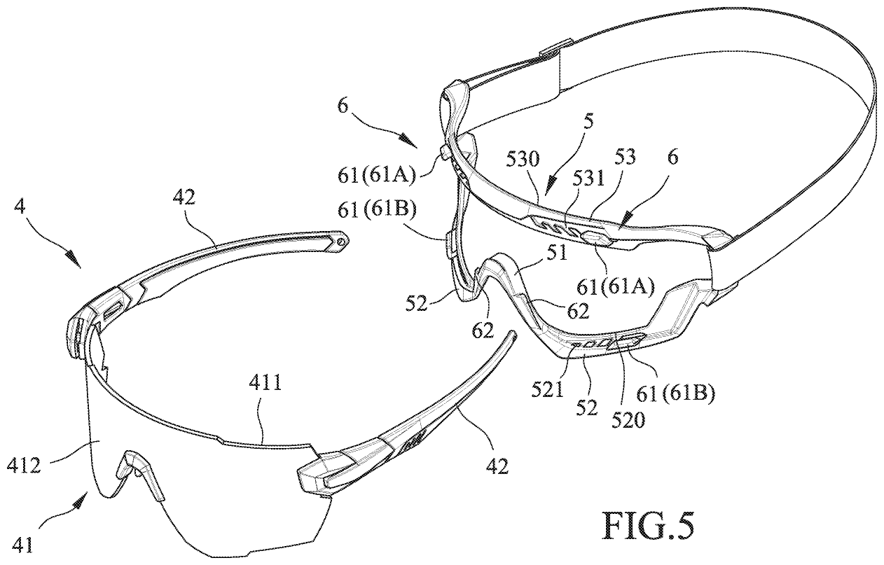

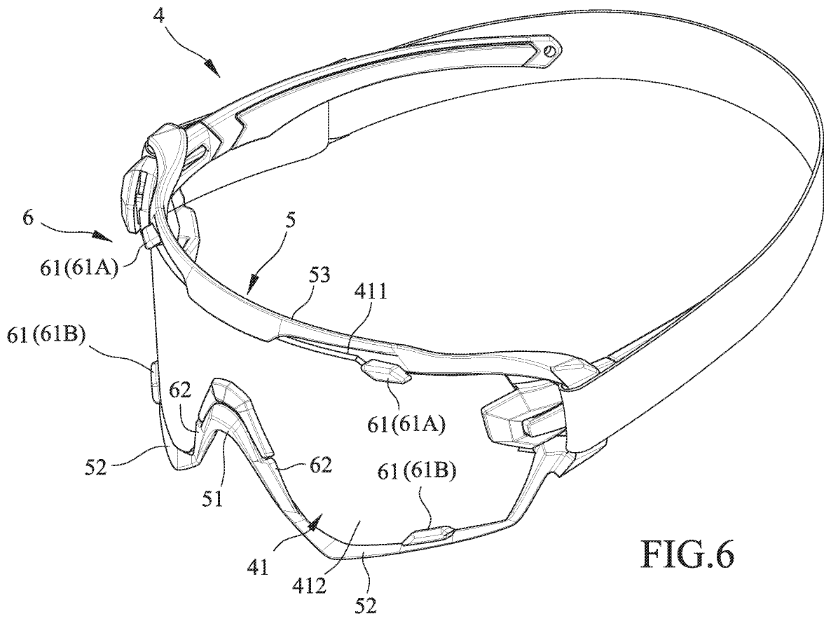

Referring to FIGS. 5 and 6, a second embodiment of the eyewear assembly according to the present disclosure is shown. The second embodiment is similar to the first embodiment and the differences therebetween are described in the following. In the second embodiment, the lens unit 4 is a pair of rimless glasses and the slots 413 formed in the lens member 41 shown in FIGS. 2 to 4 are omitted. The positioning members 61A, 61B of the engaging units 6 respectively abut against upper and lower portions of the lens member 41, so that engaging forces are generated thereamong in the front-to-rear direction.

In this embodiment, the engaging units 6 further include two inclined auxiliary members 62 extending forwardly, upwardly and outwardly from the two ends of the nose bridge pad 51, respectively, and abutting against the outer surface 412 of the lens member 41. By virtue of the auxiliary members 62, positioning force in the front-rear direction can be generated so that movement of the lens member 41 relative to the frame unit 5 in the front-rear direction can be prevented. In addition, an airflow from the ambient surrounding that may render the user uncomfortable can be blocked by the auxiliary members 62.

In the second embodiment, the upper frame member 53 of the frame unit 5 has an upper frame body 530 abutting against the outer surface 412 of the lens member 41 and at least one upper inclined toothed structure 531 extending from the upper frame body 530 and abutting against the inner surface 411 of the lens member 41. The lower frame members 52 of the frame unit 5 has a lower frame body 520 abutting against the outer surface 412 and at least one lower toothed structure 521 extending from the lower frame body 520 and abutting against the inner surface 411 of the lens member 41. The lower and upper frame bodies 520, 530 and the lower and upper toothed structures 521, 531 cooperate with one another to generate positioning force in the front-rear direction, so as to prevent removal of the lens member 41 from the frame unit 5.

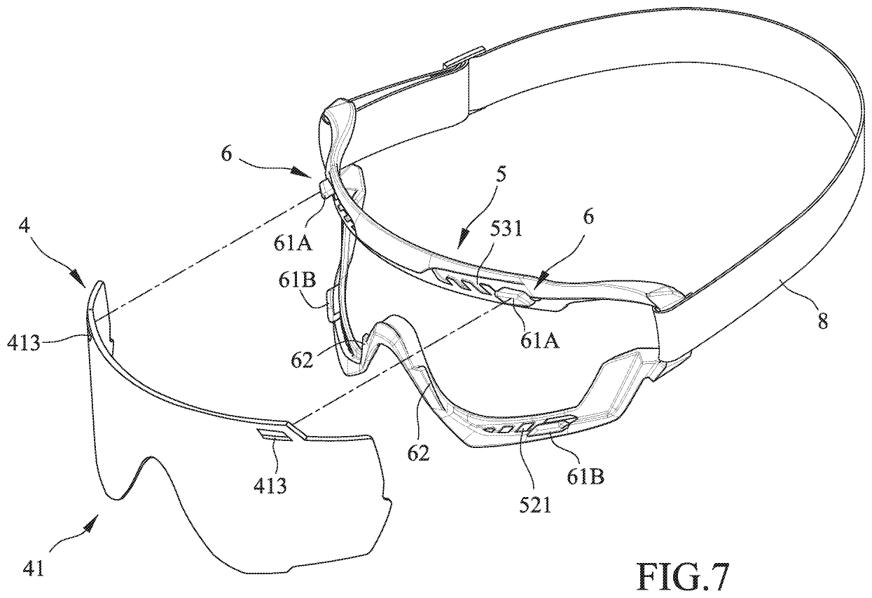

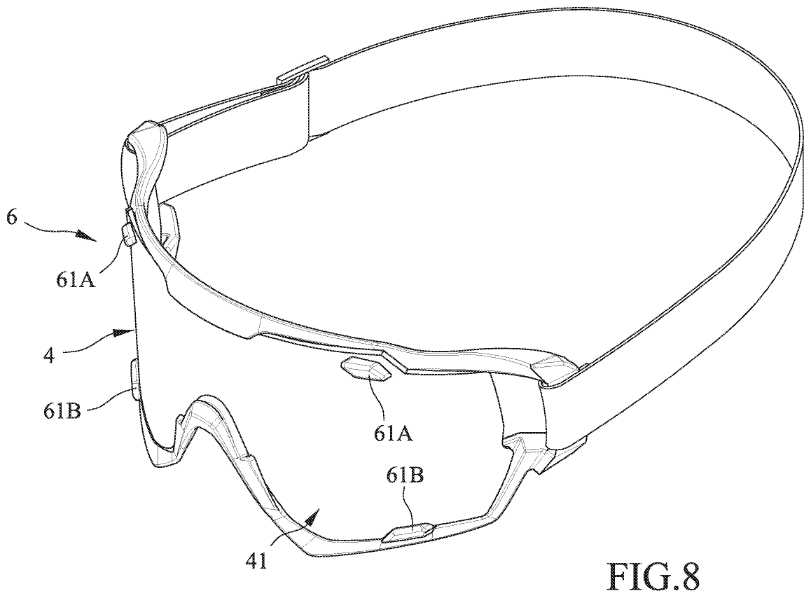

Referring to FIGS. 7 and 8, a third embodiment of the eyewear assembly according to the present disclosure is shown. The third embodiment is similar to the second embodiment and the differences therebetween are described in the following. In the third embodiment, the lens unit 4 is also a pair of rimless glasses without the temple members 42 shown in FIGS. 1 to 6, and the slots 413 are formed only in the upper portion of lens member 41. Specifically, the positioning members 61A engage the slots 413 so that engaging forces are generated between the lens member and the engaging units 6 in the front-to-rear direction. The positioning members 61B abut against the lower portion of the lens member 41. Similar to the second embodiment, the structures of the auxiliary members 62 and the upper and lower inclined toothed structure 531, 521 engaging the lens member 41 generate positioning forces in the front-rear direction to prevent removal of the lens member 41 from the frame unit 5.

To sum up, by virtue of the positioning members 61A, 61B of the engaging unit 6 extending inclinedly, the lens unit 4 can be positioned relative to the frame unit 5. Further, the structure of the connecting units 7 integrally connected to two lateral sides of the frame unit 5 provides lateral engaging forces to position the lens unit 4, and the wearing unit 8 provides positioning force in the front-rear direction, thereby stabilizing the connection between the lens unit 4 and the frame unit 5. In this way, the present disclosure provides an eyewear assembly that is relatively simple to assemble and convenient to be carried by the user.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An eyewear attachment adapted to be mounted on a lens unit that includes a lens member having an inner surface and an outer surface opposite to the inner surface, said eyewear attachment comprising:
a frame unit;
at least one engaging unit extending from said frame unit toward the lens unit and including two positioning members that extend respectively from upper and lower sides of said frame unit and that are adapted to detachably engage the lens member in such a manner that said frame unit is affixed on the lens unit;
two connecting units respectively and integrally connected to two lateral sides of said frame unit; and
an elongate wearing unit interconnecting said connecting units so as to allow an assembly of said frame unit, said connecting units and said wearing unit to be sleeved on the head of a user.

2. The eyewear attachment as claimed in claim 1, the lens unit further including two temple members extending rearwardly from two lateral sides of the lens member, wherein each of said connecting units defines a temple passage opening adapted to engage a respective one of the temple members, one of said positioning members extending from said upper side of said frame unit being inclined forwardly and downwardly, the other one of said positioning members extending from said lower side of said frame unit being inclined forwardly and upwardly.

3. The eyewear attachment as claimed in claim 2, the lens member being formed with a plurality of slots extending through the inner and outer surfaces, wherein said positioning members are adapted to detachably and respectively engage the slots.

4. The eyewear attachment as claimed in claim 2, wherein said frame unit includes a nose bridge pad having an inverted-V shape, two lower frame members respectively extending from two ends of said nose bridge pad and respectively connected to said connecting units, and an upper frame member disposed above said lower frame members and interconnecting said connecting units, said nose bridge pad, said lower frame members and said upper frame member cooperating with one another to define a lens receiving space adapted to confine the lens member therein.

5. The eyewear attachment as claimed in claim 4, wherein said engaging unit further includes two inclined auxiliary members extending forwardly, upwardly and outwardly from said two ends of said nose bridge pad, respectively, and adapted to abut against the outer surface of the lens member.

6. The eyewear attachment as claimed in claim 4, wherein said upper frame member has an upper frame body adapted to abut against the outer surface of the lens member and at least one upper inclined toothed structure extending from said upper frame body and adapted to abut against the inner surface of the lens member, said lower frame members having a lower frame body adapted to abut against the outer surface of the lens member, and at least one lower toothed structure extending from said lower frame body and adapted to abut against the inner surface of the lens member, so that said lower and upper toothed structures cooperate with each other to prevent removal of said lens member from said frame unit.

7. The eyewear attachment as claimed in claim 1, the lens member being formed with a plurality of slots extending through the inner and outer surfaces, wherein said positioning members are adapted to detachably and respectively engage the slots.

8. The eyewear attachment as claimed in claim 7, wherein said frame unit includes a nose bridge pad having an inverted-V shape, two lower frame members respectively extending from two ends of said nose bridge pad and respectively connected to said connecting units, and an upper frame member disposed above said lower frame members and interconnecting said connecting units, said nose bridge pad, said lower frame members and said upper frame member cooperating with one another to define a lens receiving space adapted to confine the lens member therein.

9. The eyewear attachment as claimed in claim 8, wherein said upper frame member has an upper frame body adapted to abut against the outer surface of the lens member, and at least one upper inclined toothed structure extending from said upper frame body and adapted to abut against the inner surface of the lens member, said lower frame members having a lower frame body adapted to abut against the outer surface, and at least one lower toothed structure extending from said lower frame body and adapted to abut against the inner surface, so that said lower and upper toothed structures cooperate with each other to prevent removal of said lens member from said frame unit.

10. The eyewear attachment as claimed in claim 1, wherein said wearing unit is one of an elastic band and a length adjustable strap with a buckle.

11. An eyewear assembly comprising:
a lens unit including a lens member that has an inner surface and an outer surface opposite to the inner surface; and
an eyewear attachment mounted on said lens unit, and including
a frame unit,
at least one engaging unit extending from said frame unit toward said lens unit and including two positioning members that extend respectively from upper and lower sides of said frame unit and that detachably engage said lens member an such a manner that said frame unit is affixed on said lens unit,
two connecting units respectively and integrally connected to two lateral sides of said frame unit, and
an elongate wearing unit interconnecting said connecting units so as to allow an assembly of said frame unit, said connecting units and said wearing unit to be sleeved. on the head of a user,

12. The eyewear assembly as claimed in claim 11, wherein said lens unit further includes two temple members extending rearwardly from two lateral sides of said lens member, each of said connecting units defining a temple passage opening engaging a respective one of said temple members, one of said positioning members extending from said upper side of said frame unit being inclined forwardly and downwardly, the other one of said positioning members extending from said lower side of said frame unit being inclined forwardly and upwardly.

13. The eyewear assembly as claimed in claim 12, wherein said lens member is formed with a plurality of slots extending through said inner and outer surfaces, said positioning members detachably and respectively engaging the slots.

14. The eyewear assembly as claimed in claim 12, wherein said frame unit includes a nose bridge pad having an inverted-V shape, two lower frame members respectively extending from two ends of said nose bridge pad and respectively connected to said connecting units, and an upper frame member disposed above said lower frame members and interconnecting said connecting units, said nose bridge pad, said lower frame members and said upper frame member cooperating with one another to define a lens receiving space confining said lens member therein.

15. The eyewear assembly as claimed in claim 14, wherein said engaging unit further includes two inclined auxiliary members extending forwardly, upwardly and outwardly from said two ends of said nose bridge pad, respectively, and abutting against said outer surface of said lens member.

16. The eyewear assembly as claimed in claim 14, wherein said upper frame member has an upper frame body abutting against said outer surface of said lens member and at least one upper inclined toothed structure extending from said upper frame body and abutting against said inner surface of said lens member, said lower frame members having a lower frame body abutting against said outer surface and ate, least one lower toothed structure extending from said lower frame body and abutting against said inner surface, so that said lower and upper toothed structures cooperate with each other to prevent removal of said lens member from said frame unit.

17. The eyewear assembly as claimed in claim 11, the lens member being formed with a plurality of slots extending through the inner and outer surfaces, wherein said positioning members detachably and respectively engage the slots.

18. The eyewear assembly as claimed in claim 17, wherein said frame unit includes a nose bridge pad having an inverted-V shape, two lower frame members respectively extending from two ends of said nose bridge pad and respectively connected to said connecting units, and an upper frame member disposed above said lower frame members and interconnecting said connecting units, said nose bridge pad, said lower frame members and said upper frame member cooperating with one another to define a lens receiving space confining the lens member therein.

19. The eyewear assembly as claimed in claim 18, wherein said upper frame member an upper frame body abutting against said outer surface of said lens member, and at least one upper inclined toothed structure extending from said upper frame body and abutting against said inner surface of said lens member, said lower frame members having a lower frame body abutting against said outer surface, and at least one lower toothed structure extending from said lower frame body and abutting against said inner surface, so that said lower and upper toothed structures cooperate with each other to prevent removal of said lens member from said frame unit.

20. The eyewear assembly as claimed in claim 11, wherein said wearing unit is one of an elastic band and a length adjustable strap with a buckle.
